(19) United States
(12) Patent Application Publication
(10) Pub. No.: US 2015/0176623 A1
(43) Pub. Date: Jun. 25, 2015

(54) Self-Drilling and Tapping Screw for Directly Screwing Together Components Without Pilot Holes and A Component Assembly Made in This Way

(71) Applicants: Bayerische Motoren Werke Aktiengesellschaft, Muenchen (DE); Arnold Umformtechnik GmbH & Co. KG, Forchtenberg (DE)

(72) Inventors: Georg VOGEL, Ingelfingen (DE); Dominik FROEHLICH, Zweiflingen (DE); Maximilian Felix WILHELM, Bockhorn (DE); Andreas FORSTER, Oberviechtach (DE); Manuel KAISER, Rutesheim (DE); Andreas SOMNITZ, Deckenpfronn (DE)

(21) Appl. No.: 14/638,211

(22) Filed: Mar. 4, 2015

Related U.S. Application Data
(63) Continuation of application No. PCT/DE2013/000489, filed on Aug. 23, 2013.

(30) Foreign Application Priority Data
Sep. 7, 2012 (DE) 10 2012 215 901.0

(51) Int. Cl. F16B 25/00; F16B 25/10

(52) U.S. Cl. CPC F16B 25/0052; F16B 25/103; F16B 25/0063

(57) ABSTRACT

A self-drilling and tapping screw for directly screwing together components includes a head and a shank integrally formed with the head. The shank has a self-tapping thread section and, in front thereof, a punch-forming section for flow punch forming. The shank further has at least one cutting edge with a chip removal function, which is essentially located in front of the self-tapping thread section, wherein on the one hand this cutting edge makes it possible to generate a clearance hole into at least one of the components by turning the screw, while on the other hand not impairing a flow punch forming in another component. A component assembly may be joined together by use of at least one such self-drilling and tapping screw.

### CROSS REFERENCE TO RELATED APPLICATIONS

This application is a continuation of PCT International Application No. PCT/DE2013/000489, filed Aug. 23, 2013, which claims priority under 35 U.S.C. §119 from German Patent Application No. 10 2012 215 901.0, filed Sep. 7, 2012, the entire disclosures of which are herein expressly incorporated by reference.

### BACKGROUND AND SUMMARY OF THE INVENTION

The invention relates to a self-drilling and tapping screw for directly screwing together components, with a head and a shank facing away from the head, wherein the shank has a self-tapping thread section and a punch-forming section arranged ahead thereof for flow punch forming.

The invention further relates to a component assembly with at least two components joined together with at least one such self-drilling and tapping screw.

A self-drilling and self-tapping screw of the respective type is used for mechanically joining or linking at least two components by creating a screwed connection. In particular, these components involve structural components for a motor vehicle body, e.g., such as sheet metal and metal profiles (which can be present as semi-finished products or spatially molded components), castings and the like.

Direct screwing is understood as establishing a screwed connection between the components to be joined without first separately incorporating holes or bores (so-called pilot holes) into these components. Direct screwing eliminates the outlay for incorporating the pilot holes, as well as the outlay for locating the holes while aligning the components.

A self-drilling and tapping screw of the respective kind is known from DE 39 09 725 Cl. DE 39 09 725 C1 also describes the so-called flow punch forming (flow punch forming process). When screwing or screwing via flow punch forming, the self-drilling and tapping screw specially designed for this purpose is pressed with its punch-forming section at the joining site against the components to be joined, which are aligned relative to each other and not pre-drilled, and made to rotate. The resultant friction causes a local heating of the joint, which enables a plasticizing of the component materials, which are hereupon plastically deformed in a radial direction and axial direction and then finally penetrated with the punch-forming section. In other words, the punch-forming section of a respective self-drilling and tapping screw has a plasticizing function or plasticizing effect vis-à-vis the component materials. During penetration by the punch-forming section, a so-called draught passage (also referred to as flow hole) is also formed at least at one of the components to be joined, into which the self-tapping thread section of the self-drilling and tapping screw then engages, and brings about a non-positive and a positive connection (i.e. a force-fit and form-fit connection) between the components.

Reference is additionally also made to the current DE 10 2010 050 979 A1 with regard to prior art and for gaining an understanding of the invention.

The flow punch forming direct screwing process described above presumes that the component materials are plastically deformable. Therefore, only metallic components (predominantly aluminum materials) have thus far been joined in the manner described. In the course of modern-day mixed construction for motor vehicle bodies (with the invention expressly not being limited hereto), non-plastically deformable materials, such as fiber-reinforced plastics (FRP) and, in particular, carbon fiber reinforced plastics (CFRP), have also been used for building purposes, which cannot be penetrated in the manner described above, i.e., with a self-drilling and tapping screw according to prior art, without being seriously damaged in the process when not pre-drilled.

The object of the invention is to provide a self-drilling and tapping screw of the above-mentioned type, with which components made out of a non-plastically deformable material can basically be directly screwed together without pre-drilling, and thereby permanently joined in this way.

This and other objects are achieved by a self-drilling and self-tapping screw according to the invention.

The self-drilling and tapping screw according to the invention for directly screwing at least two components includes a head (or screw head) and a shank (or threaded shank, bolt or threaded bolt) integrally formed with the head. The shank faces away from the head or extends away from the head. The shank has a self-tapping thread section and a punch-forming section (with plasticizing function) for flow punch forming. The punch-forming section is situated or located before and in front of the self-tapping thread section when viewed from the end. The invention provides that the shank further has at least one cutting edge with a chip removal function, which is essentially located in front of the self-tapping thread section. On the one hand this cutting edge makes it possible to generate and, in particular, to cut or to incise, a clearance hole (without a draught passage) into at least one of the components to be bolted by turning the screw. On the other hand, this cutting edge does not impair the flow punch forming process or flow punch forming (with draught passage) in at least one other of the components to be connected.

The positional indications “in front”, “before”, “after” and the like used with respect to the shank relate to an axial viewing direction proceeding from the screw tip facing away from the head in the direction of the head.

A clearance hole (or penetrating hole, respectively) is essentially characterized in that it exhibits no sleeve-like draught passage as in a flow hole, and in particular is essentially also crater-free in design.

The shaft of the screw according to the invention is designed with at least one cutting edge, which as the screw is turned allows a clearance hole (that essentially has no passage by contrast to a flow hole) to be introduced and, in particular, cut or incised into at least one of the components on the one hand, and permits flow punch forming (with passage) or essentially does not prevent or impede such flow punch forming in at least one other component. The at least one cutting edge, or an element comparable thereto in terms of function, is thus also suitable for flow punch forming. “Suitable” is understood to mean that the cutting edge has a design that enables or allows flow punch forming, or at least does not prevent flow punch forming.

The provided cutting edge is designed to have a chip removal function, so that this cutting edge can at least partially also achieve a cutting effect in relation to the component material of a component to be punched. In this regard, the cutting edge can also be referred to as a milling edge. The chip removal function is preferably achieved by giving the cutting edge a sharp edge. In addition to its chip removal function, the cutting edge can also have a deforming and, in particular, plasticizing function (or plasticizing effect), so that the component material that builds up in front of the cutting edge while turning the screw (in particular in a direction prescribed by the structural design of the screw) is deformed by the acting pressure, thereby facilitating the introduction of a clearance hole and/or the formation of a flow hole with a passage. As a consequence, the cutting edge on the shank of the screw according to the invention makes it possible to introduce or generate an essentially passage-free clearance hole in at least one of the components to be joined or bolted by cutting (to also include in particular a successive scraping or abrading of the component material) and possibly additionally plastically deforming the component material and/or also tearing or shredding the component material.

Known from DE 10 2006 034 584 A1 is a self-drilling and tapping screw whose punch-forming section is provided with ribs. As opposed to a cutting edge on a self-drilling and tapping screw according to the invention, a rib on the previously known self-drilling and tapping screw has no chip removal function. Therefore, the self-drilling and tapping screw previously known from DE 10 2006 034 584 A1 is completely unsuitable for the damage-free direct screwing of components made out of materials that are not plastically deformable.

The at least one cutting edge is situated essentially before the self-tapping thread section relative to the direction of extension of the shank or relative to the screw-in direction, and in particular exhibits an axial extension. Proceeding from the screw tip (at the free end of the shank), the cutting edge thus essentially ends before the self-tapping thread section. “Essentially” here means that the cutting edge, in some circumstances, extends into the self-tapping thread section. The at least one cutting edge can vary in design, which partially constitutes the subject matter of preferred further developments and embodiments to be explained in even greater detail below. A self-drilling and tapping screw according to the invention is preferably provided with several identically or even differently designed cutting edges. The preceding and following explanations proceed in part from just a single cutting edge, without being limited thereto.

On the one hand, the proposed cutting edge makes it possible to generate (or introduce or form) a clearance hole (or a bore hole) into at least one of the components to be joined, wherein this component in particular is the upper or uppermost component, which exhibits a screw-in side or inlet side, and faces the head of the screw. A clearance hole can also be introduced in several, in particular adjacent components inside a component assembly encompassing more than two components.

On the other hand, the cutting edge does not prevent flow punch forming in at least one other of the components to be joined, wherein this component in particular is the lower or lowermost component, which can exhibit an outlet side, and faces away from the head of the screw. Likewise this component can be an intermediate component inside of a component assembly encompassing more than two components. It can be provided that the flow hole that is to be introduced or has been introduced extends over several components or include several components inside of a component assembly encompassing more than two components.

A screw according to the invention can thus be turned around its longitudinal axis (while at the same time applying an axially acting compressive force) in order to first introduce a clearance hole into the upper component or upper components, and then turned further (while at the same time still applying an axially acting compressive force) in the same rotational direction or possibly in the other rotational direction or opposite rotational direction respectively (as will be explained in even greater detail below) in order to form a flow hole in the lower component or lower components, into which the self-tapping thread section of the screw can subsequently non-positively and positively engage (i.e. engagement with a force-fit and form-fit connection), as explained above.

A component to be punched with a clearance hole, especially being the upper component (as explained above), can in particular consist of a material that is impossible or at least difficult to plastically deform, or of a brittle material. This component is preferably composed of a non-metallic material. It is especially preferred that this component consist of a fiber-reinforced plastic (FRP), and in particular of a carbon fiber-reinforced plastic (CFRP). However, this component can likewise consist of a plastically deformable or ductile material, e.g., a metallic material, and in particular an aluminum material or a steel material. As a consequence, the screw according to the invention can be used to generate clearance holes in both brittle and ductile component materials.

The component provided for flow punch forming, especially being the lower component (as explained above), can consist of a plastically deformable material, e.g., a metallic material, and in particular an aluminum material or a steel material. However, this component can likewise consist of a non-metallic material, e.g., a plastic material. In principle, this component could also consist of a material that is impossible or at least difficult to plastically deform, or of a brittle material, for example a fiber-reinforced plastic (FRP), and in particular of a carbon fiber-reinforced plastic (CFRP).

As a consequence, the self-drilling and tapping screw according to the invention can be used to mechanically join components made out of a non-plastically deformable or brittle material with components made out of a plastically deformable or ductile material free of damages and without pilot holes, as will be explained in even greater detail below, wherein the screw according to the invention can also be used for other material combinations. This yields distinct advantages in terms of time (shorter processing time) and costs by comparison to the options known from prior art for joining such disparate components. High process reliability is also given. In addition, a unilateral accessibility (also called one-sided accessibility) on the joining site is sufficient. Another advantage may also be seen in the fact that a screwed connection created with a screw according to the invention is very repair-friendly. This is not a complete enumeration of advantages obtained from and with the invention.

It is especially preferably provided that the cutting edge be designed in such a way as to permit the introduction or generation respectively, and in particular cutting, of a clearance hole when turning the screw in one rotational direction, and allow flow punch forming while turning the screw in the other rotational direction or opposite rotational direction respectively. In other words, this means that the cutting edge is preferably situated and designed in such a way as to enable the cutting of a clearance hole when turning the screw in one direction or rotational direction (rotational direction for cutting), and also to be suitable for flow punch forming when turning the screw in the other or opposite direction (rotational direction for flow punch forming), so that the cutting of a penetrating hole or clearance hole respectively is possible or enabled when turning the screw in one rotational direction, and flow punch forming is possible or enabled when turning the screw in the other rotational direction.

The cutting edge can extend parallel to the longitudinal axis of the screw according to the invention. However, it is also possible to provide a configuration comprising a cutting edge that is inclined relative to the longitudinal axis or that is in particular coiled or helical, respectively. In addition, several cutting edges can be provided, which can be distributed on the shank periphery uniformly and in particular symmetrically, or irregularly and in particular non-symmetrically. The cutting edges can be identical or different in design.

The self-drilling and tapping screw according to the invention can be fabricated as a single piece out of a massive metallic material, e.g., in particular a steel material. A screw manufactured via forming is preferably involved. The self-tapping thread section on the shank of the screw according to the invention can be generated by thread rolling, for example.

The shank of the screw according to the invention has an axial longitudinal extension. Along its axial longitudinal extension, the shank is typically designed with a variable cross section. The variable cross section can essentially be circular in design. However, the variable cross section can also be essentially trilobular (triangular round) in design. It is further contemplated for the shank to have a variable cross sectional shape along its axial longitudinal extension. In particular, the punch-forming section can be designed with flat sections and sharper rounded sections, as described in DE 39 09 725 C1 (see FIG. 2 therein).

The self-tapping thread section on the shank of the screw according to the invention can be designed in a manner known in the art. The front or lower windings of the self-tapping thread section (i.e., those lying remote from the head) are typically designed as self-tapping (i.e., thread-forming or even thread-cutting) turns of a thread. The rear or upper windings of the thread section (i.e., those facing the head) are then typically designed as load-bearing thread windings. The self-tapping turns of a thread (self-tapping area or grooved section) can be used in particular to obtain a metric thread (e.g., an M4, M5 or M6 thread, preferably right-handed) on at least one of the components to be joined, into which the correspondingly designed, load-bearing thread turns of the same thread section can then engage. However, the thread can likewise be a non-metric one.

The punch-forming section on the shank of the screw according to the invention can be essentially conical in design. In particular, a conical design is understood to mean that the diameters or cross sectional surfaces of the shank in the punch-forming section continuously diminish or taper toward the front, i.e., in an axial direction toward the screw tip or in the screw-in direction. For example, the punch-forming section can have a conical, ballistic, paraboloid design or the like. It is preferably provided that the screw tip be rounded or spherical in design, in order to thereby obtain a large enough frictional contact area to locally heat the joining site for purposes of flow punch forming. However, the screw tip can also be flattened or circular (annulus shaped) in design, e.g., have a front-end surface extending essentially perpendicular to the longitudinal axis of the shank. Such a front-end surface has a comparatively small area in relation to the shank cross section (e.g., in the area of the self-tapping thread section).

It is preferably provided that the cutting edge begins in an axial direction after the rounded screw tip and ends before the self-tapping thread section or its self-tapping area, i.e. the self-tapping turns, or vice versa. In other words, this means that the cutting edge extends in an axial direction between the rounded screw tip and the self-tapping thread section (or vice versa).

It is especially preferably provided that the cutting edge be situated on the punch-forming section and/or on an axial section that is located between the punch-forming section and the self-tapping thread section, and in particular adjoins the punch-forming section.

In particular, it is provided that the punch-forming section of the screw according to the invention be conical in design, and exhibit a rounded screw tip, wherein the cutting edge is arranged on a conical lateral surface of this punch-forming section, and extends between the rounded screw tip and self-tapping thread section. It is especially preferably provided that the cutting edge does not extend beyond the conical lateral surface on the punch-forming section in the direction of the self-tapping thread section. As a result, it can be ensured that the diameter of the circular clearance hole generated by the cutting edge will not exceed the outer diameter (or nominal diameter) of the thread section.

It is preferably provided that the cutting edge not extend up to the screw tip, so that the screw tip has no cutting edges or is free of cutting elements respectively. The axial distance from the screw tip to the cutting edge (i.e., to the starting point of the cutting edge facing the screw tip) preferably measures less than the maximum shank diameter (or diameter of the shank) of the screw according to the invention. As a consequence, the cutting edge does not impair the function of the screw tip, which is provided in particular for locally heating the joining site. However, it can also be provided that the cutting edge extend up to the screw tip.

Between the self-tapping thread section and the especially conically designed punch-forming section, the shank of the screw according to the invention can be provided with at least one additional, e.g., cylindrical, axial section, in particular which directly adjoins the conical punch-forming section. The cutting edge can also be situated in such an axial section and in particular be designed in such a way so as not to exceed the outer diameter (or nominal diameter) of the thread section. It can further be provided that the cutting edge extend over the conical punch-forming section as well as over at least one adjacent and differently configured axial section of the shank.

It is especially preferably provided that the cutting edge be designed as a wearing edge element. This is understood in particular to mean that the cutting edge is designed to wear or dull while introducing and especially cutting a clearance hole and/or during flow punch forming, and thus essentially not impair the continued flow punch forming process. For example, it is contemplated that the cutting edge be designed or configured in such a way as to allow the introduction or cutting of a clearance hole into a first or upper component, in particular one made out of a brittle component material, and to be subjected to wear or abrasion and/or dulling in this process, or to become worn or dulled upon hitting a second component, in particular one made out of a ductile component material, so that no clearance hole is introduced or cut into the second component, but a flow hole is formed instead as the result of the axial contact pressure and rotational motion. The wearing edge can be fabricated by giving a special geometric design to the cutting edge, selecting a suitable material for the screw according to the invention, and/or by specially coating or treating the cutting edge or cutting edge areas.

The cutting edge can be formed on a shoulder or the like that faces radially outward or protrudes from the shank. In other words, this means that the circumferential surface, and in particular the conical lateral surface, of the punch-forming section exhibits a shoulder that protrudes radially (i.e., essentially perpendicular to the longitudinal axis) and includes the cutting edge. The shoulder can be designed with a constant or variable (radial) height in the axial direction. It is preferably provided that the shoulder exhibit a front side or the like, on which the sharp cutting edge is formed. When punching the holes, the front side with the cutting edge located thereon is moved against the material of the respective component (so-called counter-rotation), which generates a circular clearance hole. It is especially preferably provided that the rear side of the shoulder facing away from the front side or cutting edge be blunt and, in particular, rounded in design, so that the shoulder does not significantly impair the flow punch forming process with a rotational direction (rotational direction for flow punch forming) opposite the rotational direction for cutting.

However, the cutting edge can also be formed on a groove or the like facing radially inward. In other words, this means that the circumferential surface, and in particular the conical lateral surface, of the punch-forming section exhibits a radially inwardly facing groove, on which the cutting edge is formed. In an axial direction, the groove can be designed with a constant or variable (radial) depth. It is preferably provided that the rear outer edge of the groove relative to the rotational direction for cutting be designed as a sharp cutting edge, with which a circular clearance hole can be generated in counter rotation. It is especially preferably provided that the front outer edge of the groove relative to the rotational direction for cutting be blunt in design (e.g., rounded or with a fluid transition or free area), so as not to significantly impair the flow punch forming process with a rotational direction (rotational direction for flow punch forming) opposite the rotational direction for cutting.

It is especially preferably provided that the cutting edge, in particular when formed on a shoulder or groove, be configured like a coil (or helix) or arranged like a coil (or helix), in particular on the conical lateral surface of the punch-forming section, as explained previously. Such a coiled or coil-like cutting edge could also be referred to as a self-drilling thread turn. For example, a coiled or helical cutting edge can be advantageous for removing chips when cutting a clearance hole.

The coiled cutting edge and self-tapping thread section (or its turns respectively) on the shank of the screw according to the invention can have identical orientations (twisting or coiling direction). However, it is preferably provided that the coiled cutting edge and self-tapping thread section on the shank of the screw according to the invention have opposite orientations (or twisting or coiling direction). In other words, this means that the coiled cutting edge and self-tapping thread section are oppositely designed. The orientation of the coiled cutting edge can prescribe the rotational direction for cutting a clearance hole (e.g., for hole punching). The opposite orientation causes the flow punch forming process to take place in the opposite rotational direction, as explained above. In other words, the rotational direction must be reversed between the hole punching and flow punch forming steps. In addition, it is especially advantageous if flow punch forming and subsequent thread tapping can take place in the same rotational direction, and hence without any further reversal of rotational direction, which is made possible by the proposed embodiment. The proposed embodiment can also prevent the self-tapping thread section from jamming or inadvertently engaging while cutting a clearance hole and/or the cutting edge from jamming on one of the components to be joined during flow punch forming and thread tapping.

It is preferably further provided that the coiled cutting edge or helical cutting edge, respectively, on the punch-forming section extend approximately over a semicircle in the circumferential direction. In other words, this means that the coiled or helical cutting edge (relative to an axial top view) winds around the shank, and in particular around the punch-forming section, by 180°. Also two or three such cutting edges can be provided, which are essentially identical in design and (relative to an axial top view) offset by 180° or 120° relative to each other on the periphery of the shank or punch-forming section, so that the latter wind symmetrically around the punch-forming section or cylindrical section with a constant circumferential gap between each other. Three or more cutting edges are advantageous for a uniform true running

In an especially advantageous manner, several cutting edges can also be arranged non-symmetrically to each other on the shank, and in particular on the punch-forming section of the self-drilling and tapping screw according to the invention. It was surprisingly found that such a non-symmetrical arrangement leads to very uniform friction and contact surfaces.

An especially preferred embodiment of the screw according to the invention provides that the cutting edge be formed on the bore opening of a cross-hole in the shank, in particular in the punch-forming section. Preferably involved is an inclined cross-hole and/or a non-passing cross-hole. This will be explained in even greater detail below in conjunction with the figures.

The thread section on the shank of the screw according to the invention can reach directly up to the lower side of the head in an axial direction. However, it is preferably provided that the shank have no threads in its axial section immediately following the head. It is likewise preferably provided that the axial section of the shank immediately following the head be designed with a smaller diameter relative to the outer diameter of the self-tapping thread section (on the shank). It is further especially preferably provided that the axial section of the shank immediately following the head have no threads, and that at least segments of this thread-free section also be designed with a smaller diameter relative to the outer diameter of the self-tapping thread section. For example, these possible designs are advantageous with regard to production, in particular for thread rolling. A smaller diameter for the shaft in the section adjoining the head also makes it possible to elastically or plastically deform the material of the upper component when tightening the screw according to the invention to the desired torque. (The upper component is the component facing the head of the screw in the component assembly, against which the head also comes to abut.)

The head of a self-drilling and tapping screw according to the invention can optionally be provided on its underside with a circumferential or shank-rounding groove (or recess, cavity or the like) and designed in a variety of ways. The underside of the head is the side to which the shank is molded. In addition, the underside of the head comes to abut against the uppermost component while joining or screwing together the components. The groove can be used in the process of driving or screwing in against the screw-in direction to accommodate the component material forced upward by deformation, so that the head or underside of the head can abut completely and tightly against the upper or uppermost component.

A component assembly according to the invention encompasses a first component and a second component, which are mechanically joined or connected with each other by at least one self-drilling and tapping screw according to the invention.

For example, such a component assembly can be a component assembly for a motor vehicle body. Such a component assembly can further encompass more than two components, which are mechanically connected or joined together by at least one self-drilling and tapping screw according to the invention. Preferably involved is a mixed construction component assembly comprised of components made out of various component materials.

It is preferably provided that the self-drilling and tapping screw penetrate (or extend or engage) through the first and upper component with its shank via a generated and, in particular, incised or milled-in clearance hole, and non-positively and positively engage (i.e. engagement with force-fit and form-fit) into a flow hole formed on the second and lower component with its self-tapping thread section formed on the shank or with its load-bearing thread windings. Both the introduced clearance hole in the first and upper component as well as the threaded engagement with the second and lower component were created directly with the self-drilling and tapping screw according to the invention, specifically by way of direct screwing, i.e., without pre-drilling a pilot hole. The threaded engagement between the screw and second lower component was created via flow punch forming followed by thread tapping using the same screw, as explained above. The earlier generation of a clearance hole in the upper component quasi cleared the way for a subsequent flow punch forming in the lower component. It is likewise also contemplated for a threaded engagement to exist or be created between the screw and the first upper component as well.

The components can be sheet-like semi-finished products, profiles, castings and the like made out of metallic materials (or substances) and/or non-metallic materials (or substances). It is preferably provided that both components be made out of sheet-like semi-finished products. It is likewise preferably provided that the first upper component be made out of a sheet-like semi-finished product, and that the second lower component be a profile, casting or the like.

It is preferably provided that at least one of the components be made out of a plastic, and especially preferably out of a fiber-reinforced plastic or a fiber composite material. In particular, it is provided that the first upper component be made out of a fiber-reinforced plastic, and in particular out of a carbon fiber reinforced plastic, and that the second lower component be made out of a metallic material, such as in particular an aluminum material or a steel material. However, the reverse arrangement can also be provided. Both the upper and lower component can likewise be made out of plastic, especially preferably out of fiber-reinforced plastic or fiber composite material, and in particular out of carbon fiber reinforced plastic. Both the upper and lower component can likewise be made out of metallic material.

It is especially preferably provided that at least the upper component be made out of a brittle component material that can essentially not be plastically deformed under normal conditions, and is thus unsuitable for conventional flow punch forming (according to the prior art).

Therefore, the self-drilling and tapping screw according to the invention is outstandingly suitable for manufacturing mixed construction bonds without pre-drilling pilot holes, or for directly screwing together components or structural elements made out of various materials with, in particular, fundamentally differing material properties (e.g., brittle and ductile). In particular, the self-drilling and tapping screw according to the invention is suitable for mechanically joining together components made out of a brittle component material, e.g., a fiber-reinforced plastic or fiber composite material, and in particular out of a carbon fiber reinforced material, and components made out of ductile component material, e.g., an aluminum material or steel material.

It is especially preferably provided that the components joined together in the component assembly are additionally adhesively bonded with each other at least at the connecting or joining site created with a self-drilling and tapping screw according to the invention. The application or use of a self-drilling and tapping screw according to the invention, which can be introduced via direct screwing without a pilot hole, proves to be especially advantageous precisely in this instance, since special precautions in conjunction with the previously usual pilot holes (in particular given fiber-reinforced plastics) are not required, for example keeping the pilot holes area free of adhesive, which had led to an interruption in the adhesive seam or adhesive surface, and thus to losses in strength and/or durability. Contamination of production equipment or tools by exiting adhesive is also eliminated.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a side view of a first possible embodiment for a self-drilling and tapping screw according to the invention;

FIGS. 2a-2d are several sectional views depicting possible embodiments of cutting edges on the screw from FIG. 1;

FIG. 3 is a sectional view of a component assembly fabricated with the screw from FIG. 1;

FIG. 4 is a side view of a second possible embodiment for a self-drilling and tapping screw according to the invention;

FIG. 5 is a side view of a third possible embodiment for a self-drilling and tapping screw according to the invention;

FIGS. 6a-6b are a side and cross-sectional view of a fourth possible embodiment for a self-drilling and tapping screw according to the invention, wherein only the lower or front area of the shank is depicted;

FIGS. 7a-7d are several side views with partial sections of various configurations of a fifth possible embodiment for a self-drilling and tapping screw according to the invention, wherein only the lower or front areas of the shank are depicted;

FIGS. 8a-8e are further embodiments for a self-drilling and tapping screw according to the invention, wherein only the lower or front areas of the shank are depicted; and

FIGS. 9a-9e are possible cross sectional forms for the shank of a self-drilling and tapping screw according to the invention, in particular for the shanks depicted on FIGS. 8a-8e.

### DETAILED DESCRIPTION OF THE DRAWINGS

The direction and location information used below unrestrictedly relate only to the illustrations shown on the figures, which can deviate from real circumstances and installation situations. The features shown on the figures and/or explained below for various possible embodiments and configurations of a self-drilling and tapping screw according to the invention can also be combined to yield another possible embodiment within the framework of the invention.

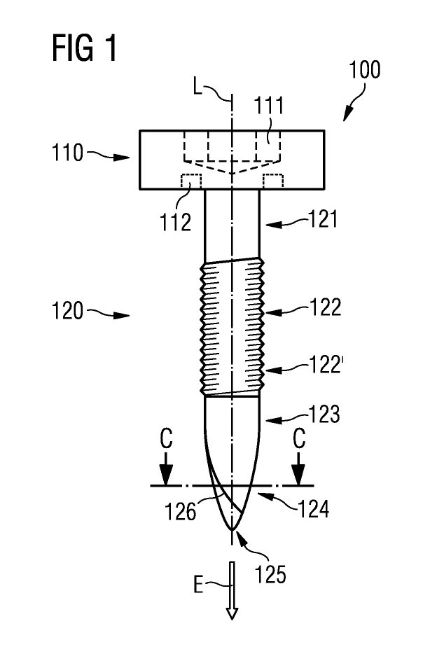

FIG. 1 shows a self-drilling and tapping screw 100 (hereinafter referred to only as screw) in a first possible embodiment. The screw 100 is a single piece, and essentially made in a rotationally symmetrical manner out of a reshaped metallic material. The longitudinal axis is labeled L. The screw 100 has a head or screw head 110, on which at least one positive element designed as a hexagon socket or a tool holder 111 is formed for inserting a tool. The positive element 111 can also have a different design. The depicted head 110 is designed as a cylindrical flat head. The head 110 could likewise also be designed as a countersunk head or in some other way. The underside of the head 110 has a groove or under-head groove 112, which can vary in shape, in particular be rounded (or concave).

The screw 100 further has a shank or bolt 120 molded onto the head 110. The straight shank 120 extends in the axial direction L away from the head 110. Proceeding from the head 110 in the axial direction, the shank 120 has an unthreaded section 121, a self-tapping thread section 122, a cylindrical section 123 and a conical and approximately tapered punch-forming section 124 with a rounded screw tip 125. As a consequence, the punch-forming section 124 is located on the axial end of the shank 120 facing away from the head 110. The lower or front windings 122′ of the self-tapping thread section 122 lying remotely from the head 110 are designed as self-tapping turns of a thread (so-called grooved section). The function of the individual sections will be explained in even greater detail below. The cross section of the shank 120 can be circular, elliptical, polygonal, trilobular or the like (see also FIG. 9). The shank 120 can also be provided with varying cross sectional shapes along its axial progression.

Such a self-drilling and tapping screw 100 can be used to connect or mechanically join together two (or more than two) components via direct screwing, i.e., without a pilot hole, as described in DE 39 09 725 C1 or also in DE 10 2010 050 979 A1. To this end, the screw 100 with its punch-forming section 124 and the rounded screw tip 125 formed thereon are pressed against the mutually positioned components to be joined together at the screw-in site or joining site by applying an axial compressive force, and made to rotate around the longitudinal axis L. The friction initially generated by the rounded screw tip 125 results in the components becoming locally heated at the joining site, which enables a plasticizing of the component materials, which hereupon are plastically deformed and punched with the punch-forming section 125 in a radial direction and axial direction with the formation of a passage or flow hole. The cylindrical section 123 on the shank 120 serves to calibrate the molded-in holes, wherein such a cylindrical section 123 between the punch-forming section 124 and self-tapping thread section 122 is not absolutely required (see FIG. 5). The self-tapping thread section 122 can then engage into the passage formed while punching the components, to which end the lower or front windings 122′ of the self-tapping thread section 122 are designed as thread-forming turns of a thread, and the upper or rear windings of the thread section 122 (i.e., those facing the head 110) are designed as load-bearing thread windings. A non-positive and positive connection is here established between the components. The screw-in process concludes when the underside of the head 110 comes to abut against the uppermost component of the component assembly. The axial forces, rotational speeds and torques applied to the screw 100 can vary over the course of the screw-in process.

In the prior art, the direct screwing process described above requires that the component materials be plastically deformable. In order to be able to also screw together and in this way non-positively or positively join together or connect other components, i.e., components made out of non-plastically deformable materials or substances, without pilot holes using such a self-drilling and tapping screw, the screw 100 according to the invention is provided with several cutting edges 126 on the punch-forming section 124. The cutting edges 126 make it possible to introduce a penetrating or clearance hole (without passage) into at least one of the components to be screwed together, in particular into the upper component, without impairing the process of flow punch forming in another of the components to be screwed together, in particular in the lower component. In the depicted possible embodiment for a self-drilling and tapping screw according to the invention, the cutting edges 126 are designed in such a way as to enable the cutting of a clearance hole while turning the screw 100 in a rotational direction, and to enable or permit flow punch forming with the creation of a passage while turning the screw 100 in the other or opposite rotational direction.

The screw 100 shown on FIG. 1 is provided with two coiled or coil-like cutting edges 126, which are symmetrically arranged on the conical lateral surface or tapered lateral surface of the punch-forming section 124, winding around the punch-forming section 124 in the circumferential direction by a respective 180° or in a semicircle. Only one cutting edge 126 is visible in the illustration depicted. With regard to the orientation or twisting direction of the thread section 122, the two coiled cutting edges or blades 126 exhibit an opposite orientation or twisting direction. In the screw 100 shown, the self-tapping thread section 122 has a right-handed design. Therefore, the coiled cutting edges 126 have a left-handed design. This reflects a preferred embodiment of a screw according to the invention.

With respect to the axial direction of the extension of the shank 120, the cutting edges 126 lie before the self-tapping thread section 122 proceeding from the thread tip 125. The depicted possible embodiment has a cylindrical section 123 between the self-tapping thread section 122 and punch-forming section 124, wherein the cutting edges 16 are only situated on the punch-forming section 124, and do not project as far as into the cylindrical section 123. The cutting edges 126 do not extend up to the screw tip 125 in the other axial direction. In other words, the cutting edges 126 do not exceed the lateral surface of the punch-forming section 124 in both axial directions. This retains the functionality of the rounded screw tip 125 in terms of flow punch forming on the one hand, and ensures that the outer diameter of the shank 120 measured by way of the cutting edges 126 does not exceed the outer diameter of the self-tapping thread section 122 on the other. In other words, the cutting edges 126 in this case do not overlap the nominal diameter of the thread to be tapped in the components.

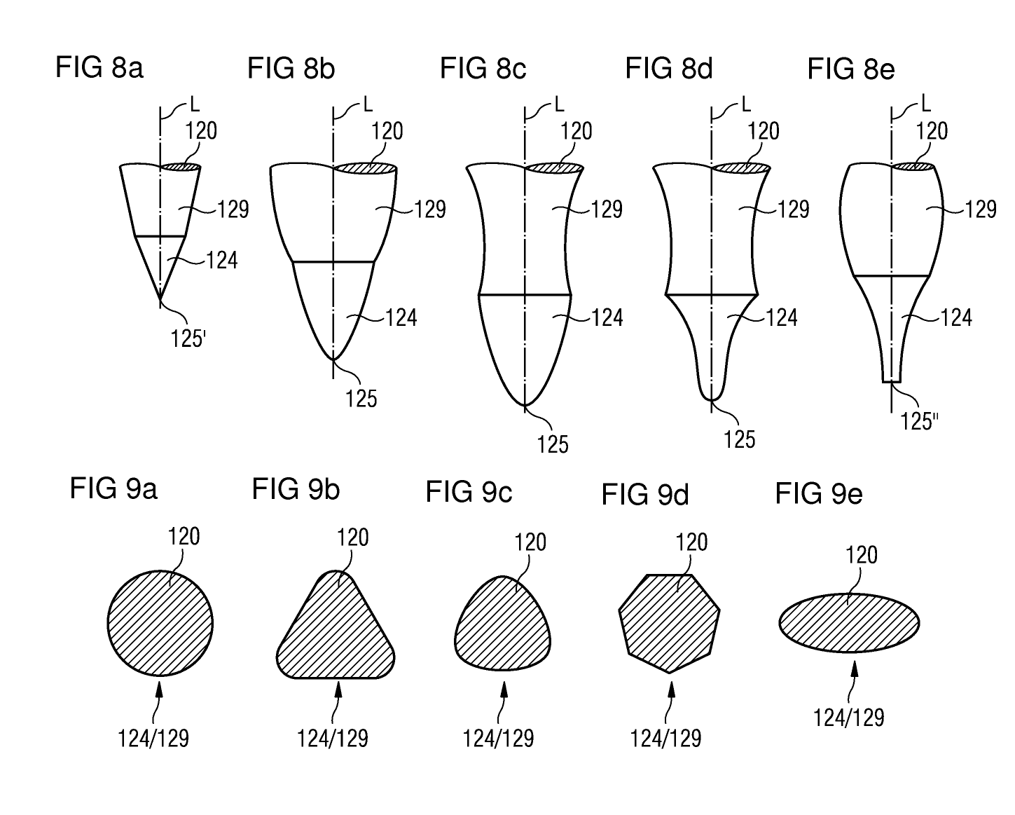

However, embodiments are also contemplated in which the cutting edges 126 extend as far as into the cylindrical section 123 and/or reach up until the screw tip 125. Also contemplated are embodiments in which the cutting edges 126 essentially are located only in the cylindrical section 123 or some other axial section (e.g., see reference number 129 on FIG. 8) between the self-tapping thread section 122 and punch-forming section 124. As a consequence, the cutting edges 126 can extend up to the self-tapping thread section 122 or even into the self-tapping thread section 122, and in particular into the grooved section 122′.

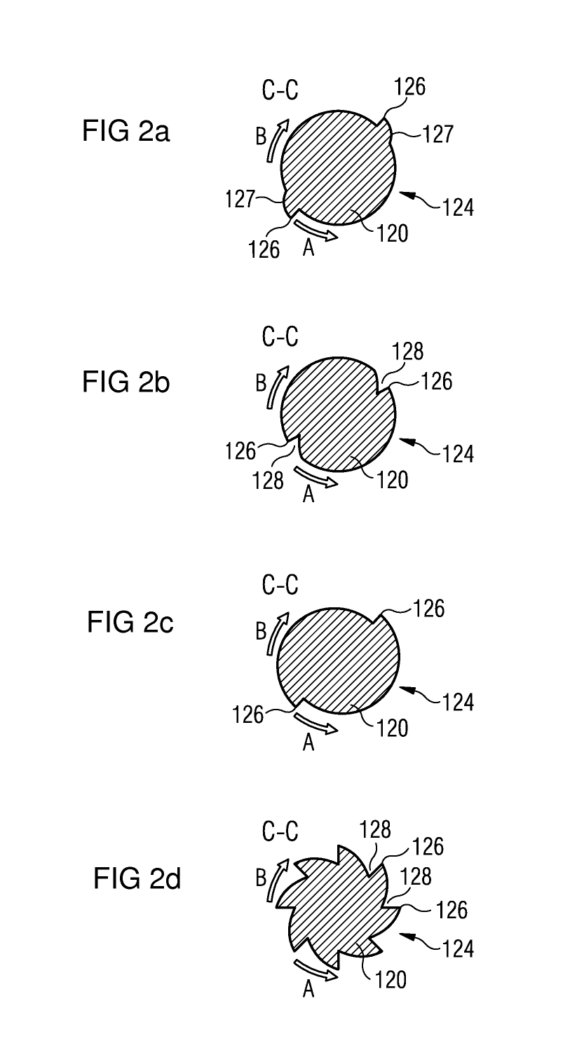

Possible embodiments of the cutting edges 126 will now be explained in more detail below using the sectional views shown in FIG. 2 based on the sectional progression C-C indicated on FIG. 1. However, the cutting edges 126 can also have a differing design.

FIG. 2a shows a first possible embodiment in which the two cutting edges 126 are formed on shoulders 127 that face radially outward or protrude from the conical lateral surface of the punch-forming section 124. More than two cutting edges 126 can comparably also be provided, e.g., three cutting edges 126. The shoulders 127 can be designed with a constant radial height or a variable radial height in an axial direction.

The shoulders 127 follow a coiled progression (as described above), and are arranged or formed symmetrically to each other. A non-symmetrical arrangement is likewise contemplated. The shoulders 127 each encompass a front side facing in the rotational cutting direction A, which bears the sharp cutting edges 126. The cutting edges 126 lie on a circumferential circle that is larger than the diameter of the shank 120 in the punch-forming section 124. While punching out a clearance hole, the front sides bearing the cutting edges 126 are moved counter-clockwise or in rotational cutting direction A by the material of the respective component, which at least partially generates a continuous circular hole or round hole by way of a chip removal action. The shoulders 127 are blunted and, in particular, rounded on their rear sides facing away from the front sides or cutting edges 126, so that the shoulders 127 do not significantly impair the flow punch forming process with a rotational direction B (rotational direction for flow punch forming) opposite the rotational cutting direction A.

FIG. 2b shows a second possible embodiment in which the two cutting edges 126 are formed on grooves or cutting grooves 128 that face radially inward. More than two cutting edges 128 can likewise also be provided. The grooves 128 can also be referred to as cutting notches, and have a cross sectional shape different than the one depicted. The grooves 128 can be designed with a constant radial depth or a variable radial depth in an axial direction.

The grooves 128 follow a coiled progression (as described above), and are arranged or formed symmetrically, or if necessary even non-symmetrically, to each other. The outer groove edges at the rear in relation to the rotational cutting direction A are designed as sharp cutting edges 126, which can be used to counter-currently generate a continuous circular hole or round hole, as explained above. The outer groove edges at the front in relation to the rotational cutting direction A are blunted and, in particular, rounded (e.g., with flowing transitions), so that the grooves 128 do not significantly impair the flow punch forming process with a rotational direction B (rotational direction for flow punch forming) opposite the rotational cutting direction A. The grooves 128 also help transport away chip products (chip removal) opposite the screw-in direction E (as indicated on FIG. 1).

FIGS. 2c and 2d show additional possible embodiments, for which the preceding explanations in conjunction with FIGS. 2a and 2b apply analogously. The possible embodiment according to FIG. 2c is characterized in particular by free areas or free angles in front of the cutting edges 126. The free areas also help transport away chip products opposite the screw-in direction E. The possible embodiment according to FIG. 2d is characterized in particular by numerous (more than two) cutting edges 126, thus yielding a star-shaped cross sectional contour in the section 124.

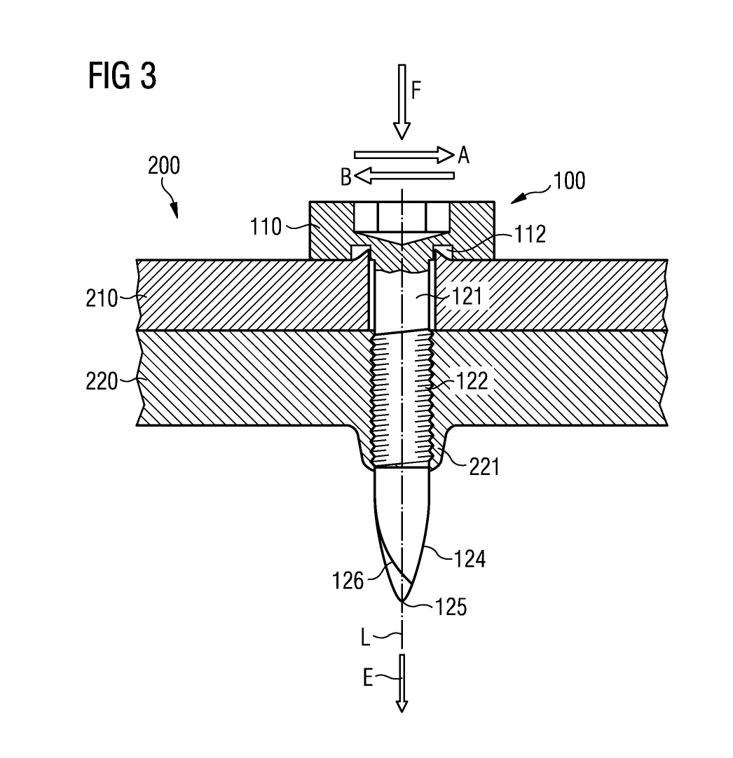

FIG. 3 shows a cutout from a component assembly 200 that includes a first upper sheet-like component 210, a second lower sheet-like component 220 and at least one screw 100. The illustration only shows a single joining site or screwing site to which the two components 210 and 220 are joined or connected by use of a screw 100 according to the invention, wherein the components 210 and 220 can also be joined together with several screws 100. In addition, the components 210 and 220 can be adhesively bonded flatly with each other, at least on the screwing site. The components 210 and 220 can also be referred to as mating parts. A component assembly 200 can also encompass more than two components.

The upper component 210 is the component facing the head 110 of the screw 100, against which the head 110 or its underside also abuts. The upper or first component 210 has an inlet side in relation to the screw 100. The lower component 220 has the component facing away from the head 110. The lower component 220 exhibits an outlet side in relation to the screw 100. For example, the upper sheet-like component 210 is made out of a fiber-reinforced plastic, in particular out of a CFRP material, wherein these materials exhibit no plastic properties. For example, the lower component 210 can be an aluminum or steel sheet. Both the upper component 210 and lower component 220 can have a spatial design. In particular the lower component 220 can also be a sectional strip, a casting with attachment flange, or the like.

The two components 210 and 220 are positively and non-positively joined with the screw 100 in such a way that the screw 100 along with its shank 120 extends through the upper component 210 via an introduced and, in particular, incised clearance hole, and along with its self-tapping thread section 122 formed on the shank non-positively and positively engages into a flow hole formed on the lower component 220. The upper component 210 is here quasi-clamped between the head 110 and lower component 220. The passage formed during flow-punch forming on the lower component 220 is labeled 221. Depending on the component thickness of components 210 and 220, the punch-forming section 124 of the screw 100 protrudes out of the lower component 220 on the outlet side, or possibly projects into a hollow space belonging to the lower component 220. As opposed to the illustration shown on FIG. 3, the self-tapping thread section 122, and in particular the self-tapping turns of the thread 122′ (grooved section), can protrude out of the lower component 220.

For purposes of direct screwing, the two components 210 and 220 are first positioned relative to each other. The screw 100 with its rounded screw tip 125 is then pressed against the upper component 210 on the inlet side, which takes place using a suitable tool fitting that is positively joined with the tool holder 111. The axially acting compressive force is labeled F, wherein the direction of the compressive force F also corresponds to the screw-in direction E of the screw 100. Turning the screw 100 in the rotational cutting direction A causes the cutting edges 126 to introduce a clearance hole into the upper component 210, which is at least partially accompanied by a chipping of the component material, as explained at length above. At roughly the point where the screw tip 125 hits the lower component 220, a reversal in rotational direction takes place, so that the screw 100 continues to turn in the opposite rotational direction B (rotational direction for flow punch forming). A flow hole is here molded into the lower component 220 without any further directional reversal, into which the self-tapping thread screw 122 on the shank 120 of the screw 120 subsequently positively engages. Therefore, flow punch forming and thread tapping take place in the same rotational direction B.

According to the preceding explanations, a left-handed motion A of the screw 100 is required to cut a clearance hole into the upper component 210. A right-handed motion B of the screw 100 is required for flow punch forming and thread tapping in the lower component 220. The rotational directions for the generation or cutting of a clearance hole and for flow punch forming and subsequent thread tapping arise from the design of the cutting edges 126 and the orientation of the self-tapping thread section 122. The rotational directions can also be changed by giving the screw a different configuration. It is further contemplated for the generation or cutting of a clearance hole and subsequent flow punch forming and thread tapping to take place in the same rotational direction. It is further contemplated that the rotational direction be reversed between flow punch forming and thread tapping.

It is especially preferably provided that the cutting edges 126 be designed as wearing edges which become worn or dulled during the screw-in process, and in particular while generating or cutting a clearance hole (i.e., in the cutting process) and/or at the start of flow punch forming (i.e., in the flow punch forming process), so as to not impair the continued flow punch forming and/or to keep the generated inner diameter of the generated flow hole low (in particular under the outer or nominal diameter of the self-tapping thread section 122).

When tightening the screw 100, the component material of the upper component 210 located under the head 110 of the screw 100 is sometimes deformed. Because the axial section 121 of the shank 120 immediately adjacent to the head 110 has no threads and is designed with a smaller diameter than the outer diameter of the self-tapping thread section 122, the component material under the head 110 is able to conditionally deform into the opening. Rising component material can deform into the groove 112 on the underside of the head 110, thereby ensuring a flat and tight abutment of the head 110 against the upper component 210. However, the screw can also be designed without such a groove 112, making it possible to enlarge the head locating surface and diminish the contact pressure on the upper component 210.

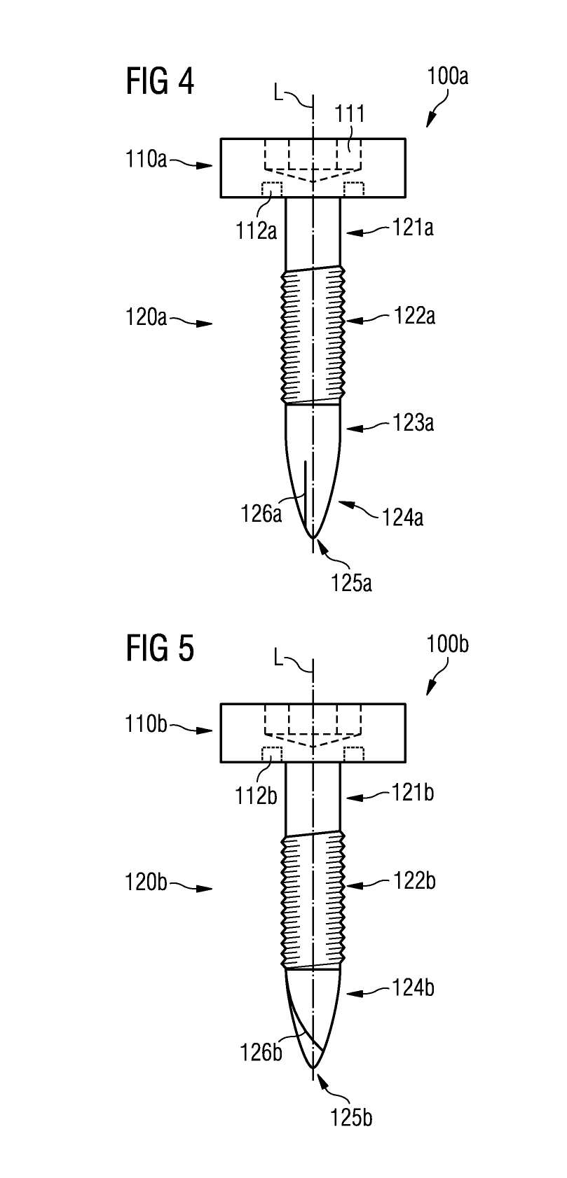

FIG. 4 shows a second possible embodiment for a self-drilling and tapping screw according to the invention. With regard to the other possible embodiments, the same reference numbers are used for the same or functionally identical elements or components, but with the addendum “a”. The screw 100a can exhibit all features of the other possible embodiments with the exception of the differences enumerated below. The corresponding explanations apply analogously.

In the screw 100a, the cutting edges 126a on the punch-forming section 124a are straight and parallel to the longitudinal axis L in design. The punch-forming section 124a can accommodate several such straight cutting edges 126a, which can be arranged symmetrically, i.e., with uniform circumferential gaps, or also non-symmetrically relative to each other. As was also the case in the first possible embodiment, the cutting edges 126a neither project into the cylindrical section 123a nor up to the rounded screw tip 125. The cutting edges 126a can have a cross section of the kind shown in FIG. 2 and described above. Otherwise, the statements made in connection with the first possible embodiment apply analogously.

FIG. 5 shows a third possible embodiment of a self-drilling and tapping screw according to the invention. With regard to the other possible embodiments, the same reference numbers are used for the same or functionally identical elements or components, but with the addendum “b”. The screw 100b can exhibit all features of the other possible embodiments with the exception of the differences enumerated below. The corresponding explanations apply analogously.

In the screw 100b, the shank 120b is designed without a cylindrical section 123. With respect to the screw-in direction, the self-tapping thread section 122b passes directly over into the punch-forming section 124b, if necessary with a suitably designed transition. The cutting edges 126b extend in an axial direction between the self-tapping thread section 122b and rounded screw tip 125b, without reaching into the thread section 122b and without reaching up to the screw tip 125. The cutting edges 126b are coiled, but can also be straight, as shown on FIG. 4 and explained above. Otherwise, the statements made in connection with the other possible embodiments apply analogously.

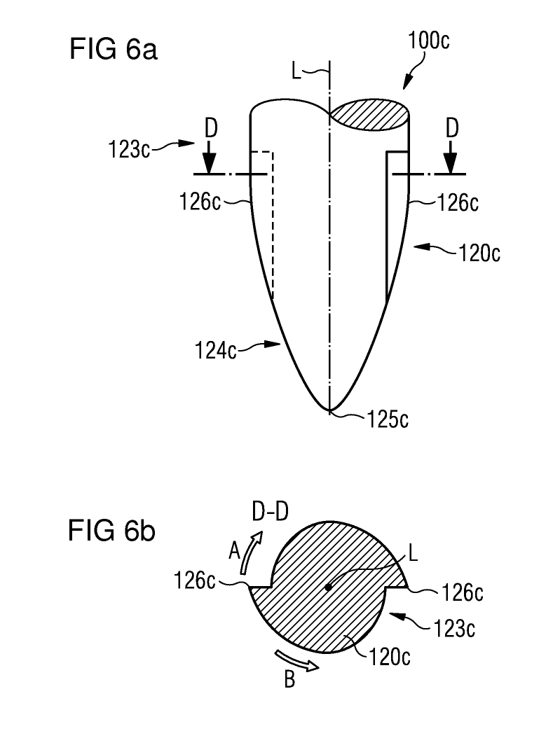

FIG. 6a shows a fourth possible embodiment of a self-drilling and tapping screw according to the invention, wherein only the lower region of the shank is depicted. With regard to the other possible embodiments, the same reference numbers are used for the same or functionally identical elements or components, but with the addendum “c”. The screw 100c can exhibit all features of the other possible embodiments with the exception of the differences enumerated below. The corresponding explanations apply analogously.

As opposed to the possible embodiments explained above, the straight or possibly even coiled cutting edges 126c are designed in such a way as to extend beyond the punch-forming section 124c in an axial direction (L) and reach as far as into the cylindrical section 123c. In the example shown, the cutting edges 126 extend in an axial direction equally over the punch-forming section 124c and cylindrical section 123c, wherein other length distributions (e.g., ⅓ to ⅔, ¼ to ¾ or vice versa) are also possible. The axial distance from the rounded screw tip 125c is larger than in the possible embodiments outlined above. While being screwed in, the cutting edges 126c thus only engage the component material (in particular the upper component 210) at a later point. The number of two cutting edges 126 is only an example. The symmetrical configuration of the cutting edges 126c is also only an example.

Another difference with respect to the previously described possible embodiments is the divergent orientation of the rotational cutting direction A and flow punch forming rotational direction B, as graphically depicted by the sectional illustration on FIG. 6b, according to the sectional progression D-D indicated on FIG. 6a.

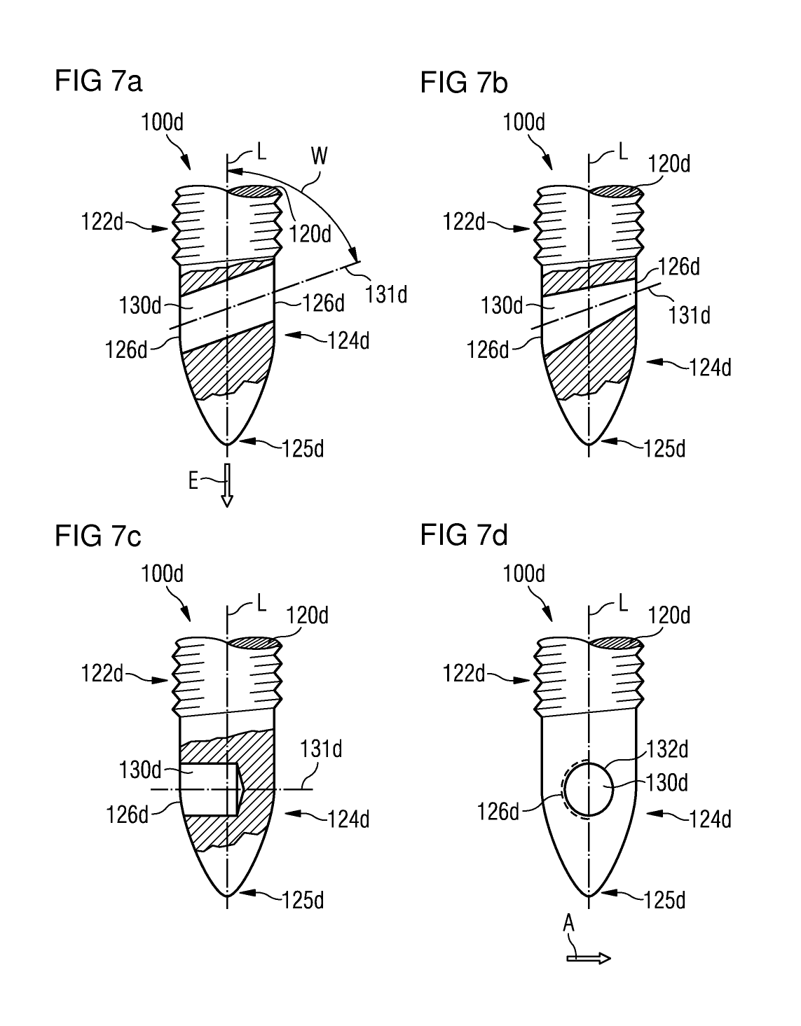

FIGS. 7a-7d show various configurations for a fourth possible embodiment of a self-drilling and tapping screw according to the invention, wherein only the lower or front areas of the shanks are here depicted. With regard to the other possible embodiments, the same reference numbers are used for the same or functionally identical elements or components, but with the addendum “d”. The screw 100d can exhibit all features of the other possible embodiments with the exception of the differences enumerated below. The corresponding explanations apply analogously.

As with the screw 100b according to FIG. 5, the screw 100d shown on FIG. 7a is designed without a cylindrical section between the self-tapping thread section and punch-forming section. The punch-forming section 124d thus directly follows the self-tapping thread section 122d. The punch-forming section 124d has a cross-hole 130d designed as a penetrating bore, on which at least one bore edge and preferably both bore edges on the bore openings are designed at least partially as a cutting edge or cutting edges 126d, as will be explained in even greater detail below.

The cross-hole 130d is designed as a cylindrical penetrating bore, whose diameter can correspond to 0.3 to 0.7 times the shank nominal diameter (in particular the nominal diameter or outer diameter of the self-tapping thread section 122d). The bore axis 131d is inclined relative to the longitudinal axis L by an angle W (angle of inclination). The angle W can assume a value of between 10° and 90°. At an angle W of 90°, the cross-hole 130d extends perpendicular to the longitudinal axis L. The cross-hole 130d can advantageously serve to accommodate and possibly also transport away chipping products, wherein the chipping products generated by the cutting edge(s) 126d are conveyed away opposite the screw-in direction E through the penetrating bore 130d, and can then be vacuumed off, for example.

It is especially preferably provided that the cross-hole 130d be inclined in such a way that the lower bore edge of the upper or rear bore opening (the bore opening on the right-hand side in the illustration) is located in roughly the same axial position as the upper bore edge of the lower or front bore opening (the bore opening on the left-hand side in the illustration), and that both bore openings be designed with a cutting edge 126d, which yields a relatively long cutting edge 126d overall in an axial direction.

The screw 100d shown on FIG. 7b is essentially identical to the screw depicted in FIG. 7a, wherein the cross-hole 130d is designed as a conical or tapered cross-hole. The diameter ratio for the bore openings can range from 10:1 to 3:1 (diameter ratio between the larger bore opening and smaller bore opening). The preceding explanations otherwise apply. The cross-hole 130d can also have a different configuration, for example consist of two conical bore sections or of a conical and cylindrical bore section, which converge roughly on the longitudinal axis L.

The screws 100d depicted on FIG. 7a and FIG. 7b can also have a cylindrical section or some other axial section (e.g., see reference number 129 on FIG. 8), which is situated between the self-tapping thread section 122d and punch-forming section 124d. The cross-hole 130d can then be arranged in the punch-forming section 124d or in the adjacent axial section. It is further contemplated for the cross-hole 130d with bore axis 131d running at an inclination to extend between the punch-forming section 124d and the adjoining axial section.

The screw 100d shown on FIG. 7c is essentially identical to the screw depicted in FIG. 7a, wherein the cross-hole 13d is designed as a cylindrical blind hole bore, which extends essentially perpendicular or orthogonal to the longitudinal axis L. The blind hole bore 130d can also have an inclined bore axis 131d and/or a conical design. The preceding explanations otherwise apply.

FIG. 7d presents another side view depicting the bore edge 132d of a bore opening in the cross-hole 130d, e.g., the screw shown on FIG. 7c. The entire bore edge 132d can be designed as a cutting edge 126d. However, it is preferably provided that only part, especially only about half, of the bore edge 132d be designed as a cutting edge 126d (i.e., over an arc section of 180°). With respect to the indicated rotational cutting direction A, only the left-hand side of the bore edge 132d is preferably designed as a cutting edge 126d, as denoted by the dashed line.

The screw 100d shown in FIG. 7d can be used to achieve very good direct screwing results, in particular in mixed construction, wherein in particular the very good chip removal effect must be emphasized, which is advantageous above all when joining together fiber-reinforced plastics (FRP) and, in particular, carbon fiber reinforced plastics (CFRP). The features depicted in FIG. 7d and explained above can also be combined into additional embodiments. It is further contemplated for a screw 100d to have several such cross-holes 130d, which can possibly also overlap each other.

FIGS. 8a-8e show additional possible embodiments of a self-drilling and tapping screw according to the invention, wherein only the lower areas of the shanks 120 are depicted. The punch-forming sections 124 conically designed according to the above definition are each adjoined by an axial section 129 in the direction of the self-tapping thread section (not shown). As a consequence, the depicted axial sections 129 extend between the self-tapping thread sections and punch-forming sections 124. The axial sections 129 are not cylindrical, but rather conical (or tapered), and in particular convex or concave (in relation to the side views shown). The axial sections 129 differ in terms of their geometric configuration and/or their axial length. The cutting edges are not depicted. According to the preceding figures and explanations, the cutting edges can be situated on the punch-forming section 124 and/or on the axial sections 129. In particular, cross-holes can be provided, as shown on FIG. 7. The cutting edges can also be formed on a shoulder-like transitional section between the axial sections 124 and 129. It is further contemplated for the punch-forming section 124 to not be conical, but rather cylindrical, for example, and have a pointed, rounded or flattened screw tip.

FIG. 8a shows a possible embodiment with a sharp screw tip 125′. FIG. 8e shows a possible embodiment in which the screw tip is not rounded, but rather flattened with a front-end surface 125″. The screw tip can likewise also be designed with a circular front-end surface.

FIGS. 9a-9e show possible cross sectional shapes for shanks, and, in particular, for the shanks depicted in FIG. 8a-8e. FIG. 9a illustrates a circular cross section, FIG. 9b and FIG. 9c trilobular cross sections, FIG. 9d a polygonal cross section (e.g., heptagonal), and FIG. 9e an elliptical cross section. The shank 120 of a self-drilling and tapping screw 100 according to the invention can be provided with different cross sectional shapes along its axial longitudinal extension.

A self-drilling and tapping screw according to the invention can also be used to join together more than two components. In addition, the invention is not limited to the described possible embodiments and configurations, component materials or substances and material combinations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A self-drilling and tapping screw for directly screwing together components, the screw comprising:
a head; and
a shank integrally formed with the head, wherein
the shank has a self-tapping thread section and a punch-forming section, the punch-forming section being arranged in front of the thread section and being configured for flow punch forming,
the shank has at least one cutting edge configured with a chip removal function, the cutting edge being located essentially in front of the thread section, and
the cutting edge is configured to generate a clearance hole in at least one of the components to be screwed together via rotation of the screw, while not impairing flow punch forming by the punch-forming section in another one of the components.

2. The self-drilling and tapping screw according to claim 1, wherein
the cutting edge is located on the punch-forming section or on an axial section of the shank lying between the punch-forming section and the thread section.

3. The self-drilling and tapping screw according to claim 2, wherein
the cutting edge does not extend up to a screw tip, whereby the screw tip is free of any cutting elements.

4. The self-drilling and tapping screw according to claim 1, wherein
the cutting edge does not extend up to a screw tip, whereby the screw tip is free of any cutting elements.

5. The self-drilling and tapping screw according to claim 1, wherein the cutting edge is designed for predetermined wear.

6. The self-drilling and tapping screw according to claim 3, wherein the cutting edge is designed for predetermined wear.

7. The self-drilling and tapping screw according to claim 1, wherein the cutting edge is formed on a shoulder that projects radially outward.

8. The self-drilling and tapping screw according to claim 1, wherein the cutting edge is formed on a groove extending radially inward.

9. The self-drilling and tapping screw according to claim 8, wherein the cutting edge is helical.

10. The self-drilling and tapping screw according to claim 7, wherein the cutting edge is helical.

11. The self-drilling and tapping screw according to claim 10, wherein the helical orientation of the cutting edge is opposite that of the thread section.

12. The self-drilling and tapping screw according to claim 9, wherein the helical orientation of the cutting edge is opposite that of the thread section.

13. The self-drilling and tapping screw according to claim 9, wherein the helical cutting edge extends over a semicircle in a circumferential direction.

14. The self-drilling and tapping screw according to claim 10, wherein the helical cutting edge extends over a semicircle in a circumferential direction.

15. The self-drilling and tapping screw according to claim 11, wherein the helical cutting edge extends over a semicircle in a circumferential direction.

16. The self-drilling and tapping screw according to claim 12, wherein the helical cutting edge extends over a semicircle in a circumferential direction.

17. The self-drilling and tapping screw according to claim 1, wherein the cutting edge is formed at a bore opening of a cross-hole in the shank.

18. A component assembly, comprising:
a first component;
a second component;
a self-drilling and tapping screw for directly screwing together the first and second components, the screw comprising:
a head; and
a shank integrally formed with the head, wherein
the shank has a self-tapping thread section and a punch-forming section, the punch-forming section being arranged in front of the thread section and being configured for flow punch forming,
the shank has at least one cutting edge configured with a chip removal function, the cutting edge being located essentially in front of the thread section, and
the cutting edge is configured to generate a clearance hole in at least one of the components to be screwed together via rotation of the screw, while not impairing flow punch forming by the punch-forming section in another one of the components.

19. A component assembly according to claim 18, wherein the first component is a non-plastically deformable component and the second component is a plastically deformable component.

20. A component assembly according claim to 19, wherein the cutting edge is located on the punch-forming section or on an axial section of the shank lying between the punch-forming section and the thread section.
